(19) United States
(12) Patent Application Publication
(10) Pub. No.: US 2019/0176679 A1
(43) Pub. Date: Jun. 13, 2019

(54) VEHICLE LAMP ASSEMBLY

(71) Applicant: Ford Global Technologies, LLC, Dearborn, MI (US)

(72) Inventors: Stuart C. Salter, White Lake, MI (US); Aaron Halonen, Brighton, MI (US); Diego Elias Ramirez, Livonia, MI (US); Steven J. Antilla, Brighton, MI (US)

(73) Assignee: Ford Global Technologies, LLC

(21) Appl. No.: 15/888,590

(22) Filed: Feb. 5, 2018

Related U.S. Application Data
(60) Provisional application No. 62/596,287, filed on Dec. 8, 2017.

(51) Int. Cl. B60Q 1/00; B60Q 1/32; B60Q 9/00; B60Q 1/30; B60Q 3/74; B60Q 3/30; B60Q 1/24

(52) U.S. Cl. CPC B60Q 1/0023; B60Q 1/323; B60Q 9/006; F21Y 2115/10; B60Q 3/74; B60Q 3/30; B60Q 1/24; B60Q 1/302

(57) ABSTRACT

A vehicle lamp assembly is provided herein. The lamp assembly includes a circuit board, a first light source configured to direct emitted light rearwardly of the housing, and a second light source configured to direct emitted light laterally outward from the housing disposed between a housing and a lens. A temperature sensor is operably coupled to the circuit board. The intensity of emitted light from the first or second light source is varied based on a detected temperature.

### CROSS-REFERENCE TO RELATED APPLICATIONS

This application claims priority under 35 U.S.C. § 119(e) and the benefit of U.S. Provisional Application No. 62/596,287 entitled “VEHICLE LAMP ASSEMBLY,” filed on Dec. 8, 2017, the entire disclosure of which is incorporated herein by reference.

### FIELD OF THE INVENTION

The present disclosure generally relates to vehicle lamp assemblies, and more particularly, to vehicle lamp assemblies disposed within a closure member, such as a lift gate, of a vehicle.

### BACKGROUND OF THE INVENTION

Lamp assemblies are commonly employed in vehicles to provide various lighting functions. For some vehicles, it may be desirable to have a more efficient lamp assembly that may be capable of providing additional illumination proximate the vehicle.

### SUMMARY OF THE INVENTION

According to one aspect of the present disclosure, a vehicle lamp assembly is provided herein. The lamp assembly includes first and second light sources disposed between a housing and a lens. The first light source is configured to direct emitted light rearwardly of the housing and the second light source is configured to direct emitted light laterally outward from the housing. A temperature sensor is operably coupled with a circuit board. An intensity of the emitted light from the first or second light source is varied based on a detected temperature.

According to another aspect of the present disclosure, a vehicle lamp assembly is provided herein. The vehicle lamp assembly includes a housing operably coupled with a lens. A circuit board and a light source are between the housing and the lens. A controller is operably coupled with the circuit board and a power source. The intensity of light emitted from the light source is varied based on a detected charge level of the power source.

According to yet another aspect of the present disclosure, a vehicle lamp assembly is disclosed. The lamp assembly includes a circuit board and a light source between a housing and a lens. A controller is operably coupled with the circuit board and a power source. An intensity of emitted light from the light source is varied based on a detected charge level of the power source. A temperature sensor is operably coupled to the circuit board. The intensity of light emitted from the first or second light source is varied based on a detected temperature.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating, according to some examples;

FIG. 1B is a top view of a luminescent structure rendered as a discrete particle, according to some examples;

FIG. 1C is a side view of a plurality of luminescent structures rendered as discrete particles and incorporated into a separate structure;

FIG. 2 is a rear perspective view of an automotive vehicle with a rear hatch of the vehicle in a closed position, according to some examples;

FIG. 3 is a rear perspective view of the vehicle with the rear hatch in an open position and the lamp assembly disposed within a trim panel, according to some examples;

FIG. 4 is a rear perspective view of the vehicle with the lamp assembly emitting light in laterally outward and vehicle rearward directions, according to some examples;

FIG. 5 is a rear perspective view of the vehicle with the lamp assembly emitting light vehicle rearward, according to some examples;

FIG. 6 is a front perspective view of the lamp assembly, according to some examples;

FIG. 7 is a front exploded view of the lamp assembly, according to some examples;

FIG. 8 is a flow diagram of a method of increasing an intensity of light emitted from the lamp assembly, according to some examples;

FIG. 9 is a flow diagram of a method of operating the lamp assembly based on a temperature of the lamp assembly, according to some examples; and

FIG. 10 is a flow diagram of a method of operating the lamp assembly based on a percent a power supply is charged, according to some examples.

### DETAILED DESCRIPTION OF THE PREFERRED EXAMPLES

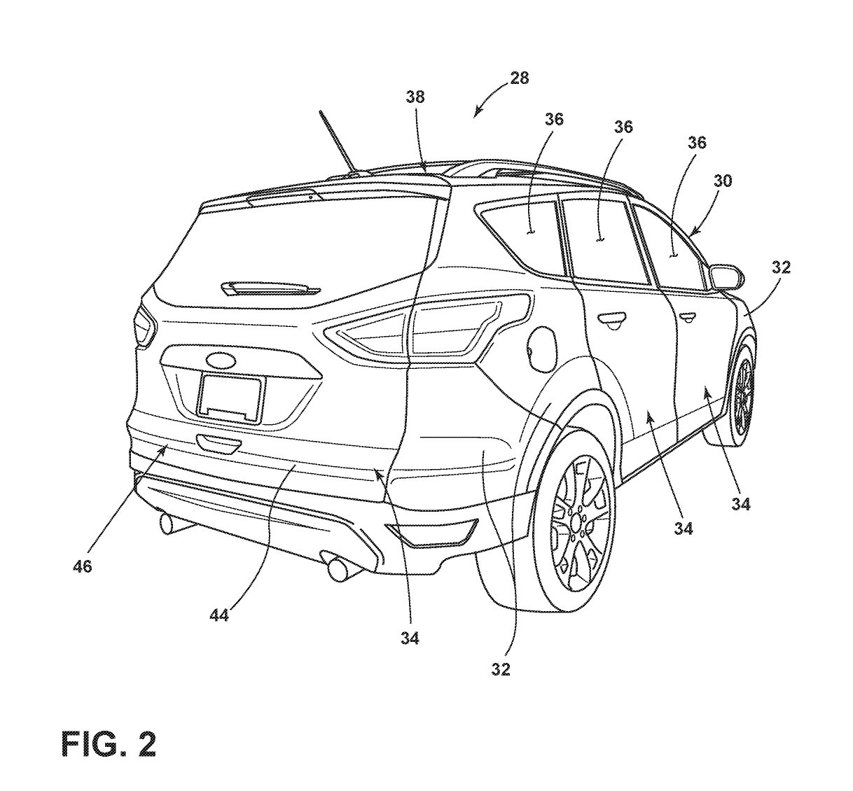

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a lamp assembly that may be integrated within a closure member of a vehicle, such as a door, a lift gate, and/or a tailgate. In some examples, the light assembly is disposed within a trim panel that is coupled to the closure member. The lamp assembly may provide illumination within the vehicle and/or to an area proximate the vehicle when the closure member is placed in an open position. One or more light sources within the lamp assembly may illuminate in response to various inputs in a forwardly, rearwardly, outwardly, and/or downwardly direction. The lamp assembly may be operably coupled with one or more phosphorescent and/or luminescent structures to luminesce in response to predefined events. The one or more luminescent structures may be configured to convert emitted light received from an associated light source and re-emit the light at a different wavelength generally found in the visible spectrum.

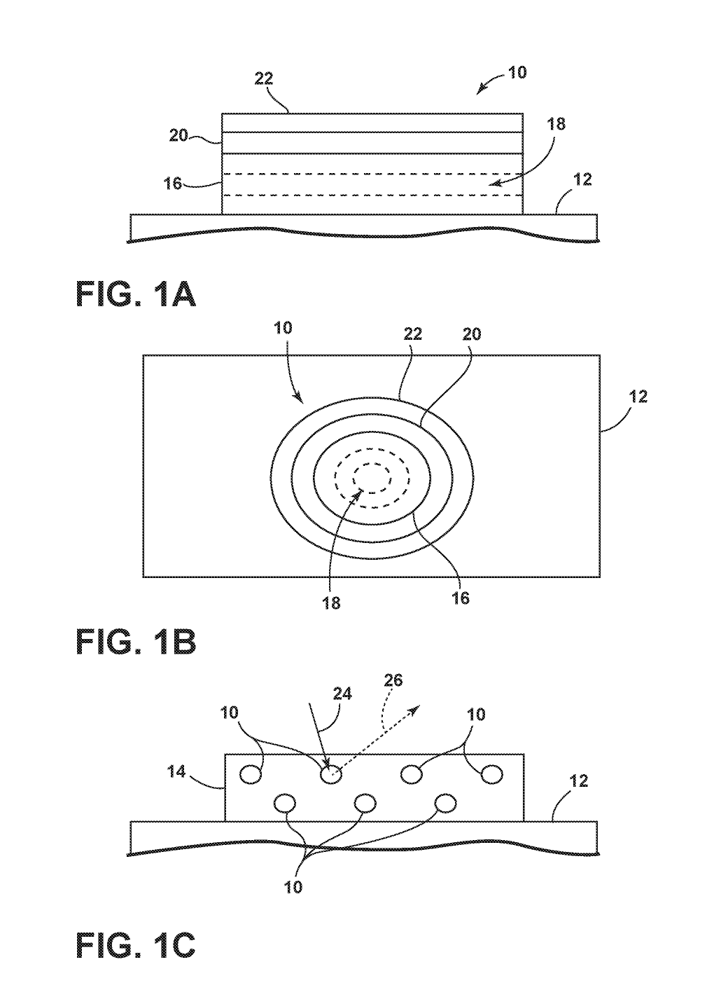

Referring to FIGS. 1A-1C, various exemplary examples of luminescent structures 10 are shown, each capable of being coupled to a substrate 12, which may correspond to a vehicle fixture or vehicle-related piece of equipment. In FIG. 1A, the luminescent structure 10 is generally shown rendered as a coating (e.g., a film) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film) that may then be applied (as shown) or integrated with the substrate 12.

At the most basic level, a given luminescent structure 10 includes an energy conversion layer 16 that may include one or more sublayers, which are exemplarily shown in broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an emitted light 24 of a specific wavelength, thereby causing the light to undergo a conversion process. Under the principle of down conversion, the emitted light 24 is converted into a longer-wavelength, converted light 26 that is outputted from the luminescent structure 10. Conversely, under the principle of up conversion, the emitted light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In various examples, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the emitted light 24 and the converted light 26 is known as the Stokes shift and serves as the principal driving mechanism for an energy conversion process corresponding to a change in wavelength of light. In the various examples discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

According to various examples, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4D¹ to 4f¹ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the emitted light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

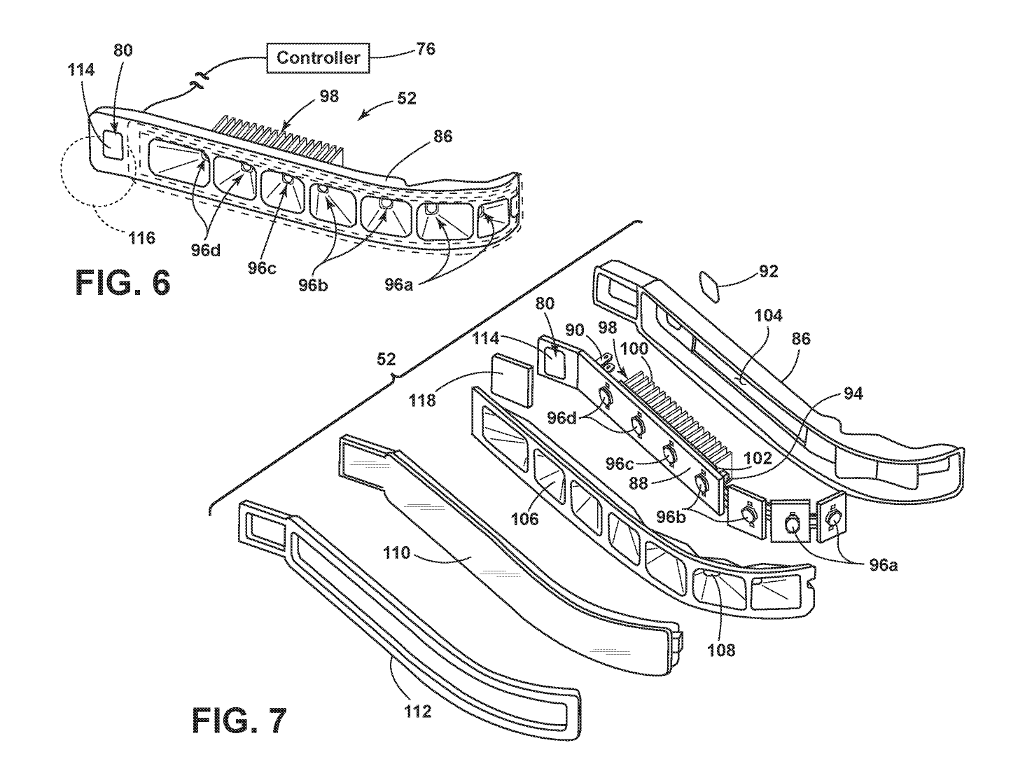

According to various examples, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in various examples, the rare earth aluminum garnet type Ce phosphor may serve as the luminescent material 18 with ultra-short-persistence characteristics, which can emit the converted light 26 by absorbing purple to blue emitted light 24 emanated from one or more light sources 96 (FIG. 6). According to various examples, a ZnS:Ag phosphor may be used to create a blue-converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material 18 known in the art may be utilized without departing from the teachings provided herein.

Additionally, or alternatively, the luminescent material 18, according to various examples, disposed within the luminescent structure 10 may include a long-persistence luminescent material 18 that emits the converted light 26, once charged by the emitted light 24. The emitted light 24 may be emitted from any excitation source (e.g., any natural light source, such as the sun, and/or any artificial light sources 96). The long-persistence luminescent material 18 may be defined as having a long decay time due to its ability to store the emitted light 24 and release the converted light 26 gradually, for a period of several minutes or hours, once the emitted light 24 is no longer present.

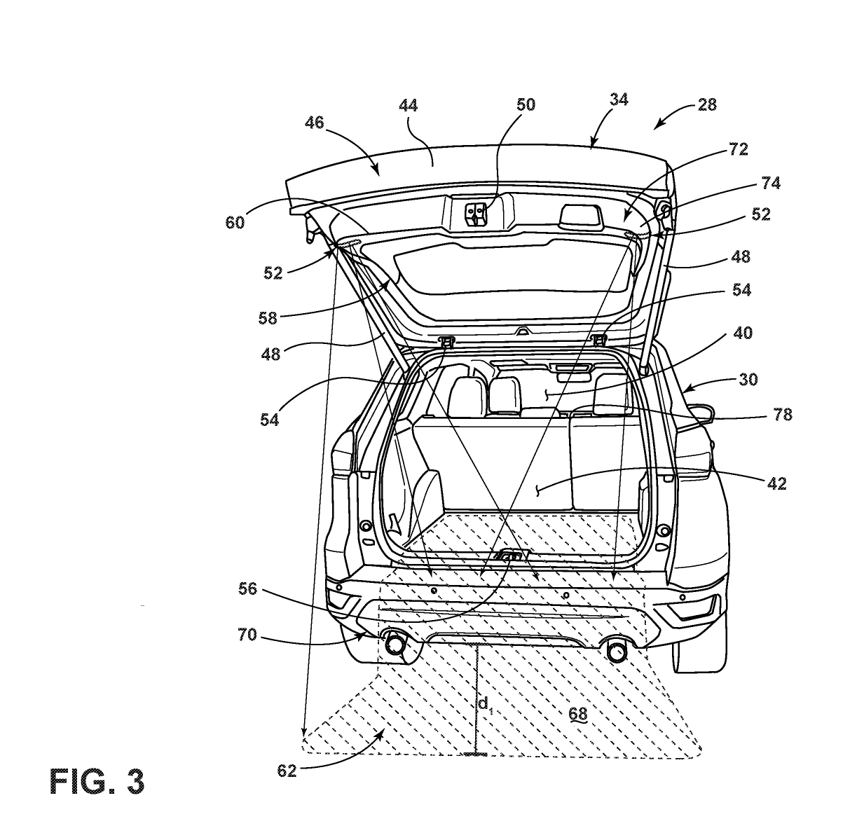

The long-persistence luminescent material 18, according to various examples, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in various examples, for a period substantially longer than 60 minutes (e.g., the period may extend 24 hours or longer, and in some instances, the period may extend 48 hours). Accordingly, the long-persistence luminescent material 18 may continually illuminate in response to excitation from any one or more light sources 96 that emit the emitted light 24, including, but not limited to, natural light sources (e.g., the sun) and/or any artificial one or more light sources 96. The periodic absorption of the emitted light 24 from any excitation source may provide for a substantially sustained charge of the long-persistence luminescent material 18 to provide for consistent passive illumination. In various examples, a light sensor 78 (FIG. 3) may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example, doped di-silicates, or any other compound that is capable of emitting light for a period of time once the emitted light 24 is no longer present. The long-persistence luminescent material 18 may be doped with one or more ions, which may correspond to rare earth elements, for example, Eu2+, Tb3+, and/or Dy3. According to one non-limiting exemplary example, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to various examples, may be a translucent white color, and in some instances reflective, when unilluminated. Once the luminescent structure 10 receives the emitted light 24 of a particular wavelength, the luminescent structure 10 may emit any color light (e.g., blue or red) therefrom at any desired brightness. According to various examples, a blue emitting phosphorescent material may have the structure Li₂ZnGeO₄ and may be prepared by a high-temperature solid-state reaction method or through any other practicable method and/or process. The afterglow may last for a duration of 2-8 hours and may originate from the emitted light 24 and d-d transitions of Mn2+ ions.

According to an alternate non-limiting example, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

With reference to FIGS. 2-5, a vehicle 28 generally includes a body 30, a chassis, and a powertrain driving road wheels to move the vehicle 28. The body 30 generally includes body panels 32, doors 34, windows 36, and a roof 38 that generally defines a passenger compartment 40 of the vehicle 28. One or more of the doors 34 may provide access to the passenger compartment 40 and/or a cargo compartment 42. For example, the cargo compartment 42 may be accessible through a rear door 44, which may be configured as a hatch 46. The rear door 44 is movably attached to one or more of the proximately disposed body panels 32 of the vehicle 28 such that the rear door 44 can be moved from a closed position (FIG. 2) to an open position (FIG. 3). In some examples, gas springs 48 may assist in movement of the rear door 44 when a latch 50 is released. As will be described in greater detail below, a lamp assembly 52 may be used in conjunction with the rear door 44 to provide illumination proximately thereto through one or more light sources 96 (FIG. 6). It will be appreciated that any closure member disposed on the vehicle 28, including, but not limited to, a door, a trunk lid, a hatch 46, a tailgate, a lift gate, a hood, a gas cap, etc. may include the lamp assembly 52 set forth herein without departing from the spirit of the present disclosure.

Referring to FIGS. 3-5, the hatch 46 is connected to the body 30 of the vehicle 28 by one or more hinges 54. Moreover, the hatch 46 may be selectively retained in a closed position by a latch 50 engaging a striker 56. It will be appreciated that the latch 50 may be released in any manner without departing from the scope of the present disclosure. An interior surface 58 of the hatch 46 may include a trim panel 60, which may be a rigid material, a fabric, or any other material thereon for creating a desired aesthetic appearance for the vehicle 28. It will be appreciated that any closure member may include an interior trim panel 60 that may include the lamp assembly 52 provided herein without departing from the scope of the present disclosure.

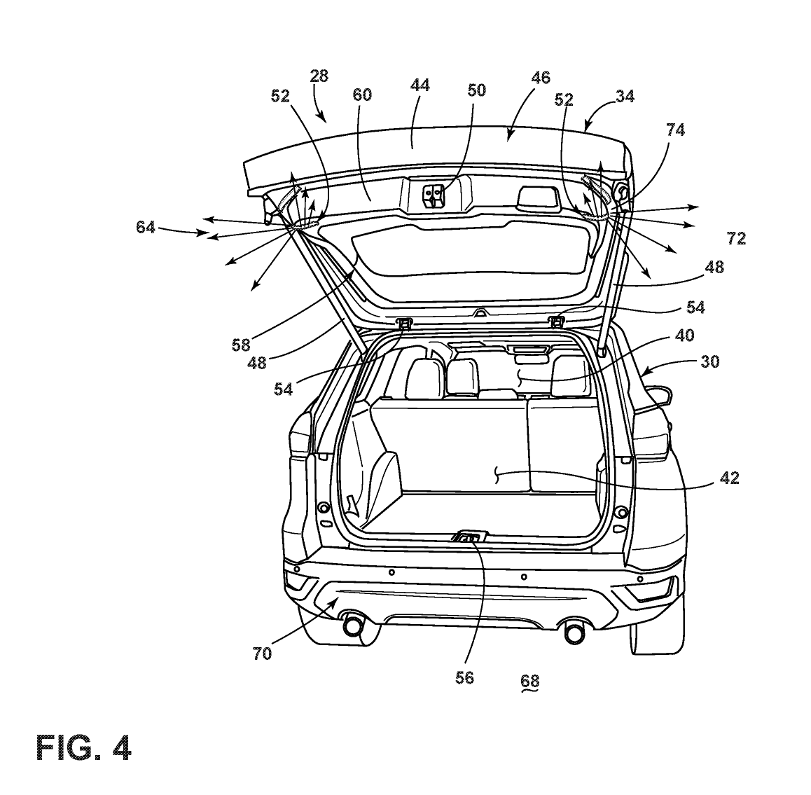

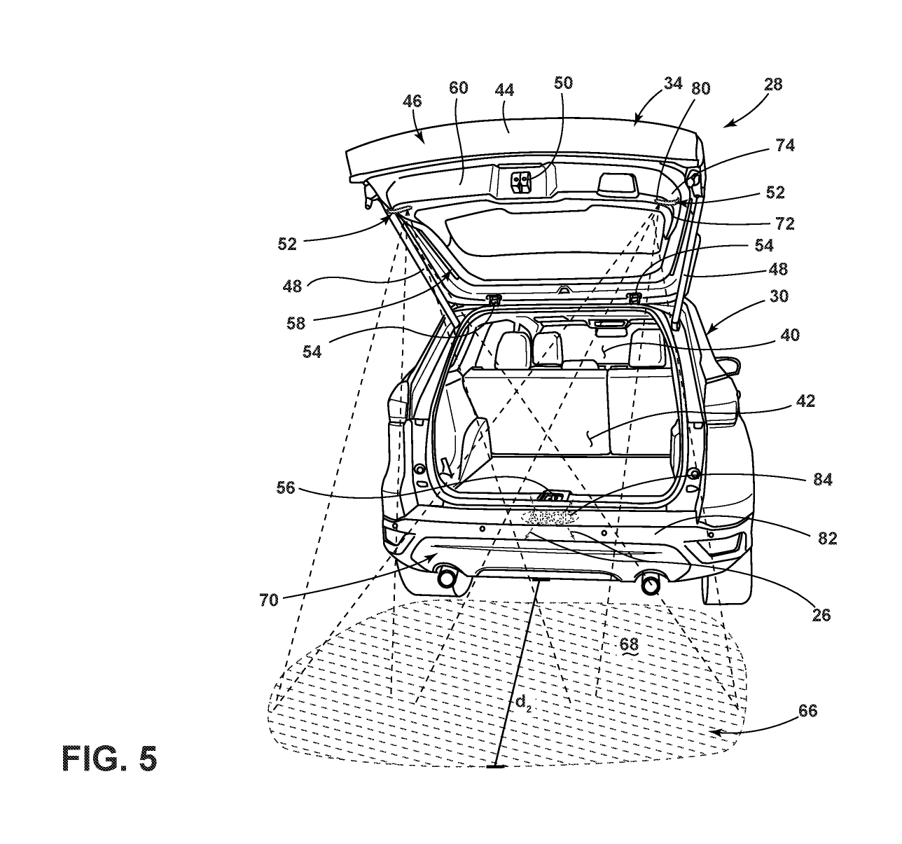

The lamp assembly 52 may be disposed within an aperture defined by the trim panel 60 and/or integrated into the trim panel 60. The lamp assembly 52 may have one or more light sources 96 (FIG. 6) that illuminate one or more illumination zones 62, 64, 66 based on predefined events, which are depicted in FIGS. 3-5. For example, as illustrated in FIG. 3, a first illumination zone 62 may include the cargo compartment 42 and/or a ground surface 68 proximate a rear portion 70 of the vehicle 28 that extends a distance d₁ from a rear portion 70 of the vehicle 28. As illustrated in FIG. 4, a second illumination zone 64 may be laterally outward and/or rearward of the vehicle 28. As illustrated in FIG. 5, a third illumination zone 66 may extend from the rear portion 70 of the vehicle 28 to a distance d₂ that is rearward of the first zone along the ground surface 68. It will be appreciated that the illumination zones 62, 64, 66 provided herein are exemplary. Accordingly, the lamp assembly 52 may illuminate some of the illumination zones 62, 64, 66 described herein, all of the illumination zones 62, 64, 66 provided herein, and/or additional illumination zones without departing from the scope of the present disclosure.

With further reference to FIG. 3, a pair of lamp assemblies 52 may be disposed on lateral sides of the trim panel 60. Each lamp assembly 52 may have a first portion extending along a first portion 72 of the trim panel 60 and a second portion that extends along a side portion 74 of the trim panel 60. In some examples, the lamp assembly 52 may emit a first intensity of emitted light 24 when the ambient temperature around the vehicle 28 is below a predefined temperature (e.g., 100 degrees Fahrenheit). If the ambient temperature around the vehicle 28 is greater than the predetermined temperature, the light assembly may emit a second, lower intensity of emitted light 24. If the temperature increases above the predetermined temperature, the emitted light 24 may gradually decrease in intensity. Once a second, higher predetermined temperature (e.g., 140 degrees Fahrenheit) is detected, the lamp assembly 52 may automatically deactivate to assist in preventing overheating.

Referring to FIG. 3, each lamp assembly 52 is electrically coupled with a controller 76 (FIG. 6). The controller 76 can provide each lamp assembly 52 with generated pulse width modulated (PWM) signals to produce the corresponding light intensity and/or light color. Alternatively, the controller 76 can directly drive the current to each lamp assembly 52 to accomplish the same variations in intensity and/or light color. In some examples, the lamp assemblies 52 may illuminate in a variable intensity, which may be used to illuminate the first illumination zone 62. In such instances, the lamp assemblies 52 may illuminate at a first intensity, such as 33% PWM. If the ambient temperature is below a predetermined temperature (e.g., 100 degrees Fahrenheit), the lamp assemblies 52 may progressively increase in intensity until the lamp assemblies 52 reach a maximum desired intensity, such as 100% PWM, or until the predetermined temperature is exceeded. In other examples, the first illumination zone 62 may be illuminated at a predefined first intensity (e.g., 50% PWM) to provide ambient lighting in the cargo compartment 42 of the vehicle 28 and/or to the ground surface 68 proximate the rear portion 70 of the vehicle 28. When the light sensor 78 detects day-like conditions, a predefined second intensity (e.g., 10% PWM) of emitted light 24 may be emanated from the lamp assembly 52.

With further reference to FIGS. 3-5, in some examples, the vehicle 28 includes a light sensor 78 that may be utilized for varying the intensity of emitted light 24 emanated from the lamp assembly 52. The light sensor 78 detects ambient lighting conditions, such as whether the vehicle 28 is in day-like conditions (i.e., higher light level conditions) and/or whether the vehicle 28 is in night-like conditions (i.e., lower light level conditions). The light sensor 78 can be of any suitable type and can detect the day-like and night-like conditions in any suitable fashion. According to some examples, the colors of light and/or intensities of the emitted light 24 from the lamp assembly 52 may be varied based on the detected conditions. The light sensor 78 may be integrated into the vehicle 28 or into the lamp assemblies 52.

With reference to FIG. 4, as provided herein, the lamp assembly 52 may selectively illuminate the various illumination zones 62, 64, 66. In some instances, as represented by the second illumination zone 64, the lamp assembly 52 may be configured to direct emitted light 24 laterally outward from the vehicle 28 and/or vehicle rearwardly. According to various examples, multicolored light sources, such as Red, Green, and Blue (RGB) LEDs that employ red, green, and blue LED packaging may be used to generate various desired colors of light outputs from a single light source, according to known light color mixing techniques. In some instances, the second illumination zone 64 may illuminate in a red color, an amber color, and/or in any other color in a steady and/or alternating fashion. Such colors and/or illumination patterns may be used to provide additional safety and/or visibility to the vehicle 28 in conjunction with one or more hazard lights of the vehicle 28. Due to the activation and deactivation of the lamp assembly 52 in an intermittent manner, heat generated by the lamp assembly 52 may be lowered. Moreover, in some examples, the intermittent activation may be simultaneous with the hazard lights disposed around the vehicle 28.

With further reference to FIG. 4, the second illumination zone 64 may be illuminated at a constant and/or variable intensity. In some examples, the first and second illumination zones 62, 64 may be illuminated simultaneously. In such instances, the first illumination zone 62 may maintain a constant illumination pattern at a varied or constant intensity while the second illumination zone 64 may be illuminated at a similar and/or varied intensity from that of the first illumination zone 62. Moreover, the second illumination zone 64 may alternate between an activated and deactivated state and/or maintain a consistent illuminated state. In instances in which the second illumination is illuminated in an intermittent manner, the power utilized by the lamp assembly 52 may be lessened when compared to illuminating the second illumination zone 64 in a steady, illuminated state.

With reference to FIG. 5, the third illumination zone 66 may illuminate an area from the rear portion 70 of the vehicle 28 to a distance that is outward of the first illumination zone 62 and/or outwardly of the hatch 46. The third illumination zone 66 may be utilized when a person is disposed rearwardly of the vehicle 28, such as when a person is participating in a tailgate with the hatch 46 in the open position. When the third illumination zone 66 is illuminated, the lamp assemblies 52 may output light in a continuous manner at a continuous and/or varied intensity.

In some examples, the first, second and third illumination zones 62, 64, 66 may be illuminated simultaneously to provide a large illuminated area proximate the rear portion 70 of the vehicle 28. In such instances, the light sources 96 may all be activated to provide continuous lighting. Moreover, the emitted light 24 from the lamp assembly 52 may progressively increase or decrease in intensity based on an amount of time the lamp assembly 52 is activated, the temperature of the lamp assembly, and/or the temperature of the ambient air surrounding the vehicle 28.

As will be provided in more detail below, one or both of the lamp assemblies 52 may include a switch assembly 80 thereon. The switch assembly 80 may activate/deactivate the one or more lamp assemblies 52, toggle the lamp assemblies 52 between the various illumination settings (i.e., selectively illuminate the various illumination zones 62, 64, 66), move the hatch 46 between open and closed positions, and/or activate/deactivate any other feature of the vehicle 28. The switch assembly 80 may be configured, as any type of proximity switch 114 (FIG. 6) can be used, such as, but not limited to, capacitive sensors, inductive sensors, optical sensors, temperature sensors, resistive sensors, the like, or a combination thereof. Moreover, the switch assembly 80 may additionally and/or alternatively include a mechanical switch of any type known in the art, such as a push button. In push button examples, a membrane may be provided as a seal over the switch. Depression of the membrane causes depression of a plunger on the switch. Internal switch contacts then change positions to provide an output signal.

With further reference to FIG. 5, in some instances, the vehicle 28 may include the luminescent structure 10 on a body feature 82 thereof, such as a bumper. The lamp assembly 52 may be configured to direct emitted light 24 at the luminescent structure 10. In some instances, the luminescent structure 10 may be integrated within a paint and/or other decorative material that is disposed on the body feature 82. In some examples, the luminescent structure 10 may define indicia 84 that signifies a make, model, feature of the vehicle 28, and/or other desired information. In operation, the luminescent structure 10 may exhibit a constant unicolor or multicolor illumination in response to receiving emitted light 24 from the lamp assembly 52.

Referring to FIGS. 6 and 7, the lamp assembly 52, according to some examples, includes a rear housing 86 for being fastened to the trim panel 60 (FIGS. 3-5). The rear housing 86 supports a circuit board, which may be configured as a printed circuit board (PCB) 88, oriented along the rear housing 86 and having control circuitry including drive circuitry for controlling activation and deactivation of the plurality of light sources 96. The PCB 88 may be any type of circuit board including, but not limited to, any flexible PCB and/or rigid PCB.

The controller 76 is configured to receive various inputs and control the lamp assembly 52 by applying signals to the light sources 96 within the lamp assembly 52. The controller 76 may be disposed within the lamp assembly 52 and/or within the vehicle 28. The controller 76 may include a microprocessor and memory, according to some examples. It should be appreciated that the controller 76 may include control circuitry such as analog and/or digital control circuitry. Logic is stored within the memory and executed by the microprocessor for processing the various inputs and controlling each of the plurality of light sources 96, as described herein. The inputs to the controller 76 may include a panel position signal, a door unlatch signal, a temperature sensor signal, a switch activation signal, and/or any other signal.

The controller 76 may include any combination of software and/or processing circuitry suitable for controlling the various components of the lamp assembly 52 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. All such computing devices and environments are intended to fall within the meaning of the term “controller” or “processor” as used herein unless a different meaning is explicitly provided or otherwise clear from the context.

A power terminal 90 is provided on the PCB 88 for passing through a seal 92 for electrical connection with a corresponding receptacle within the vehicle 28. In some examples, the power terminal 90 may be surrounded by a connector shell that is molded in conjunction with any other portion of the lamp assembly 52, such as the rear housing 86.

The lamp assembly 52 may additionally include a temperature sensor 94 positioned to sense a temperature of the lamp assembly 52, the PCB 88, the light sources 96, or any other lamp assembly 52 components. The temperature sensor 94 may, for example, include a thermistor or the like embedded within or attached to the PCB 88. The temperature sensor 94 may also or instead include an infrared detector or the like directed at the lamp assembly 52 or any component thereof. It will be appreciated that any other type of temperature sensor may be utilized without departing from the scope of the present disclosure.

With respect to the examples described herein, the light sources 96 may each be configured to emit visible and/or non-visible light, such as blue light, UV light, infrared, and/or violet light and may include any form of light source. For example, the light sources 96 may be fluorescent lights, light emitting diodes (LEDs), organic LEDs (OLEDs), polymer LEDs (PLEDs), laser diodes, quantum dot LEDs (QD-LEDs), solid-state lights, a hybrid of these or any other similar device, or any other form of light source. Further, various types of LEDs are suitable for use as the light source 96 including, but not limited to, top-emitting LEDs, side-emitting LEDs, and others. Moreover, according to various examples, multicolored light sources, such as Red, Green, and Blue (RGB) LEDs that employ red, green, and blue LED packaging may be used to generate various desired colors of light output from a single light source, according to known light color mixing techniques.

Referring again to FIGS. 6 and 7, the light sources 96, while producing emitted light 24, also emit heat. As heat is emitted from the light sources 96, a heatsink 98 captures at least a portion of this heat. The captured heat is temporarily retained within elongated members 100 of the heatsink 98. The captured heat within the heatsink 98 migrates to areas that have a lower temperature than the heatsink 98. As such, the heatsink 98, after absorbing heat from the light sources 96, exchanges, or transfers heat to cooler regions in and around the trim panel 60. In some examples, the rear housing 86 may define a void 104 through which the heatsink 98 may extend. Accordingly, the heatsink 98 may dissipate heat into a space disposed between the trim panel 60 and a body panel 32 of the vehicle 28 to increase the efficiency of the heatsink 98.

In the various examples, the elongated members 100 of the heatsink 98 can extend generally perpendicular to a back portion 102 of the heatsink 98. In such an example, the elongated members 100 can be linear or can include various angled and/or curved portions. It is contemplated that, in various instances, the elongated members 100 can extend in an angled configuration or a curved configuration, or both, relative to the back portion 102 of the heatsink 98. It is further contemplated that each elongated member 100 can have configurations that can include, but are not limited to, linear, curved, angled, and trapezoidal, among other configurations. Additionally, various cross members can be included that extend across the elongated members 100 to add structure to the elongated members 100 and also add surface area through which heat can be transferred from the lamp assembly 52. It is also contemplated that the elongated members 100 may not have a consistent length. Such configurations may include a triangular profile, a trapezoidal profile, a curved profile, an irregular profile, among other similarly shaped profiles. Various examples of the heatsink 98 may also include more than one row of elongated members 100, such as an inner layer and outer layer of elongated members 100.

In the various examples, the heatsink 98 can be made of various materials that have a high thermal conductivity. Such materials can include but are not limited to, aluminum, aluminum alloys, copper, composite materials that incorporate materials having a high thermal conductivity, combinations thereof, and other materials that are at least partially thermally conductive.

With further reference to FIGS. 6 and 7, a plurality of reflectors 106 is provided within each lamp assembly 52. The reflectors 106 may be formed integrally as depicted and each includes an aperture 108 aligned with the corresponding light source 96. The reflectors 106 are utilized for reflecting and redirecting emitted light 24 from the light sources 96 for focusing the illumination to one or more illumination zones 62, 64, 66. The reflectors 106 and corresponding light sources 96 are oriented to convey light forward, laterally outward, downward, and/or rearward of the trim panel 60 for illuminating the illumination zones 62, 64, 66.

A translucent lens cover 110 and a gasket 112 are also provided in the lamp assembly 52 for isolating various components of the lamp assembly 52 from external contaminants and weather. The lens cover 110 may include optics thereon. For example, the lens cover 110 may be configured with a Fresnel lens, a pillow optic, and/or any other type of lens or optic that is configured to disperse, concentrate, and/or otherwise direct light emitted from the lamp assembly 52 there-through in any desired manner. The optics may assist in directing emitted light 24 in a desired direction to form the various illumination zones 62, 64, 66.

With further reference to FIGS. 6 and 7, the lamp assembly 52 may include the switch assembly 80, which may be configured as an integrated proximity switch 114. The proximity switch 114 provides a sense activation field 116 to sense contact or close proximity (e.g., within ten millimeters) of an object, such as a hand (e.g., palm or finger(s)) of an operator in relation to the proximity switch 114. It will be appreciated by those skilled in the art that any type of proximity switch 114 can be used, such as, but not limited to, capacitive sensors, inductive sensors, optical sensors, temperature sensors, resistive sensors, the like, or a combination thereof.

An adhesive layer 118 may be disposed between the lens and the switch assembly 80. In some examples, the adhesive layer 118 fills a space between the lens and the switch assembly 80 to assist in removing air gaps between the circuit board and the lens to minimize any sensitivity variations in production of the lens assembly and the proximity switch 114. Further, in some instances, the adhesive layer 118 may be an optically clear adhesive. As used herein, the term “optically clear” refers to an adhesive that has a high light transmittance over at least a portion of the visible light spectrum (about 400 to about 700 nanometers), and that exhibits low haze. Both the luminous transmission and the haze can be determined using, for example, the method of ASTM-D 1003-95. In one embodiment, the adhesive has about 10% haze or less, particularly about 5% haze or less, and more particularly about 2% haze or less. It will be appreciated that the adhesive layer 118 disposed on the PCB 88 and the lens may be of any practicable material without departing from the scope of the present disclosure.

In some examples, a first set of outboard light sources 96a may be configured to direct emitted light 24 laterally outward from the vehicle 28 in a wide array of colors, possibly including an amber color. A second set of light sources 96b may be inboardly adjacent to the first set of light sources 96a and be configured to emit white light laterally outward and/or rearward of the vehicle 28 in any desired color, such as a white color. A third set of light sources 96c may emit any color of light towards the cargo compartment 42 of the vehicle 28 and/or a ground surface 68 proximate the rear portion 70 of the vehicle 28. A fourth set of light sources 96d may be configured to direct any color of light, such as red light, rearwardly of the vehicle 28 to provide additional notification to approaching vehicles and persons of the open hatch 46.

Referring still to FIGS. 6 and 7, in some examples, the light sources 96 may be capable of illuminating at 180 milliamps (mA), which may be equal to an intensity of 100% PWM. However, the light sources 96 may be illuminated at 60 mA in an initial intensity, which is 33% PWM to hold the amount of emitted light 24 steady until an ambient temperature reaches or exceeds a predetermined temperature, such as 100 degrees Fahrenheit. If the ambient temperature remains below the predetermined temperature, the lamp assembly 52 may be configured to increase the intensity of light emitted from the light sources 96.

In some examples, the lamp assembly 52 may take some time to warm the thermal mass of the lamp assembly 52, which may include the housing, the lens, the PCB 88, the heatsink 98, etc. Accordingly, even when the ambient temperature exceeds the predetermined temperature, the lamp assembly 52 may run at a higher intensity than the initial intensity until the lamp assembly 52 reaches and/or exceeds the predetermined temperature. In some instances, the amount of time that the hatch 46 is disposed in an open position may be less than the amount of time for the lamp assembly 52 to reach or exceed the predetermined temperature. Accordingly, the lamp assembly 52 may illuminate above the initial intensity during the time that the hatch 46 is disposed in the open position. Thus, in many circumstances, the lamp assembly 52 may illuminate at 1.5 to 3 times the initial intensity while the lamp assembly 52 is activated as the predetermined temperature may not be reached and/or exceeded. In such instances in which the predetermined temperature is reached and/or exceeded, the intensity of emitted light 24 may be decreased in small amounts such that the change in intensity is minimally perceivable, or non-perceivable.

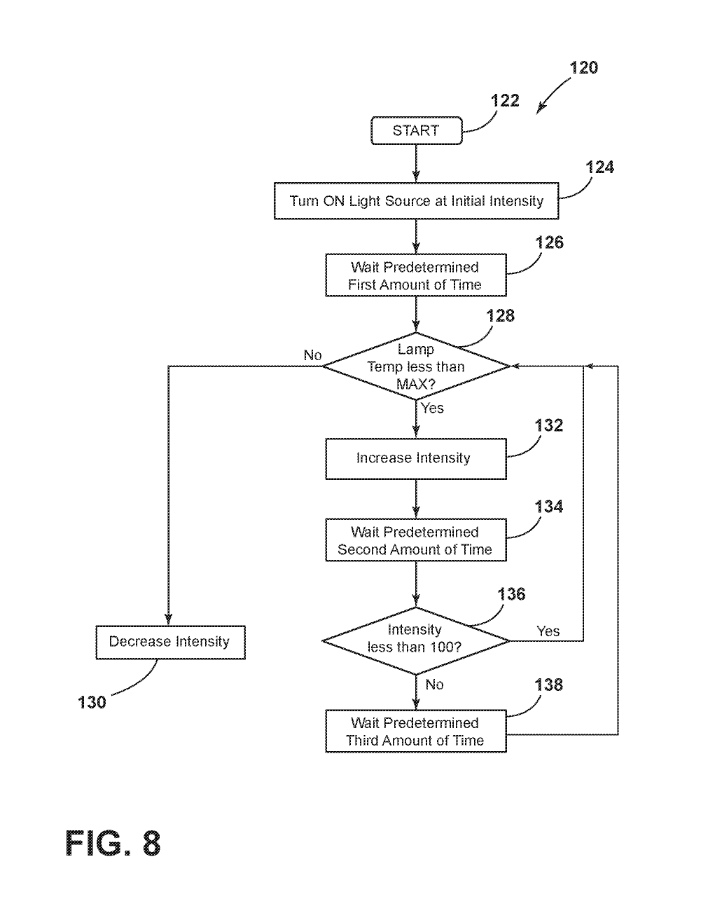

Referring to FIG. 8, a method 120 of operating the lamp assembly 52 is illustrated, according to some examples. The method begins at step 122, which may be activated by a switch actuation signal and/or for any other reason. Next, at step 124, the lamp assembly 52 may activate one or more of the light sources 96 at an initial intensity. At step 126, the lamp assembly 52 may continue to illuminate at the first intensity, unless the hatch 46 is placed in a closed position, the switch is actuated a second time, and/or any condition is met to deactivate the light sources 96. Once the light sources 96 have continually illuminated for a predetermined amount of time, such as 30 seconds, as indicated by step 126, the method continues to step 128. At step 128, the temperature of the lamp assembly 52 is measured. If the lamp assembly 52 is above a predetermined maximum (MAX) temperature, the intensity of light emitted from the one or more light sources 96 is decreased at step 130. If the temperature of the lamp assembly 52 is below the MAX temperature, the intensity of light emitted from the one or more light sources 96 is increased at step 132. At step 134, the lamp assembly 52 again remains illuminated for a second predetermined amount of time, such as 0.1 seconds. Then, at step 136, the lamp assembly 52 determines if the intensity of light emitted from the light sources 96 is less than 100% PWM. If the light sources 96 are emanating emitted light 24 at an intensity of 100%, the lamp assembly 52 continues to emit light at that intensity then proceeds to step 138. If the intensity emitted at step 136 is less than 100%, the lamp assembly 52 also returns to step 128, where the temperature of the lamp assembly 52 is measured again, and the intensity of light may be adjusted based on the temperature of the lamp assembly 52 in comparison to the MAX temperature. The lamp assembly 52 may continually loop through the method provided herein until the hatch 46 is placed in a closed position, the switch is actuated a second time, and/or any condition is met to deactivate the light sources 96.

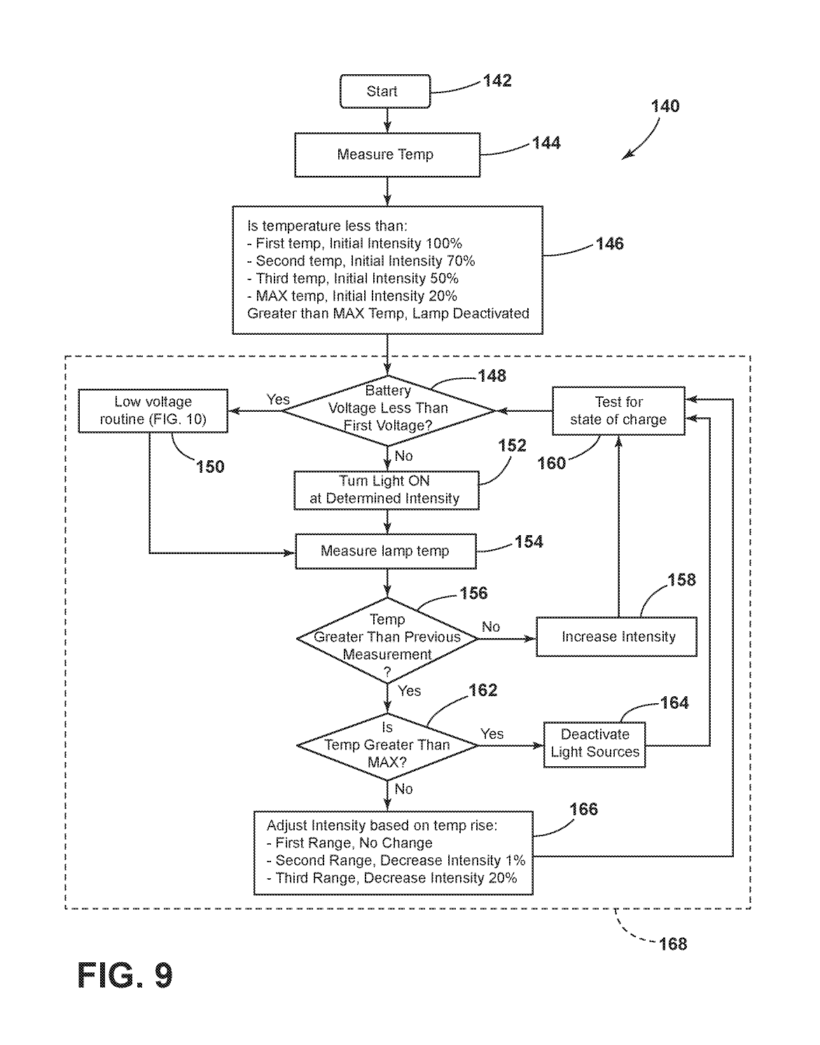

With reference to FIG. 9, a method 140 of operating the lamp assembly 52 based on the temperature of the lamp assembly 52, a status of a power source, and/or the intensity of light emitted from one or more light sources 96 within the lamp assembly 52 is illustrated, according to some examples of the lamp assembly 52 provided herein. The method begins at step 142. At step 144, the temperature sensor 94 measures an initial temperature of the lamp assembly 52. At step 146, based on the initial temperature, the lamp assembly 52 determines an initial intensity to be emitted from the lamp assembly 52. For example, it the temperature sensor 94 determines that the lamp assembly 52 is at or below a first temperature, such as 80 degrees Fahrenheit, a first initial intensity (e.g. 100% PWM) may be emitted from the lamp assembly 52. If the lamp assembly 52 is at or below a second temperature, such as 100 degrees Fahrenheit, but above the first temperature, a second initial intensity (e.g. 70% PWM) may be emitted from the lamp assembly 52. If the lamp assembly 52 is at or below a third temperature, such as 120 degrees Fahrenheit, but above the second temperature, a third initial intensity (e.g. 50% PWM) may be emitted from the lamp assembly 52. If the lamp assembly 52 is at or below a MAX temperature, such as 140 degrees Fahrenheit, but above the third temperature, a fourth initial intensity (e.g. 20% PWM) may be emitted from the lamp assembly 52. If the lamp assembly 52 exceeds the fourth temperature, the lamp assembly 52 may be maintained in a deactivated state.

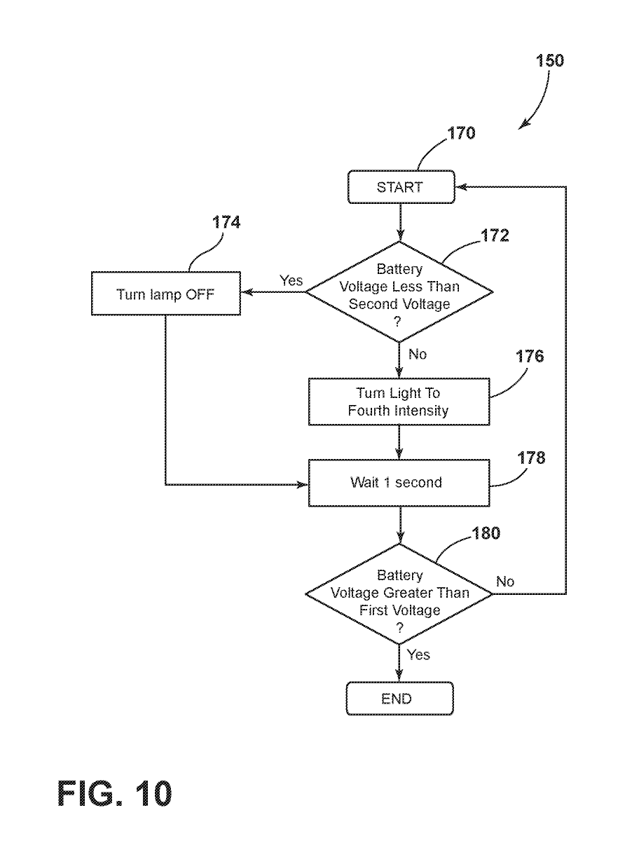

At step 148, the voltage of the power source is determined and compared to a first predetermined voltage, such as 60% of a fully charged power source. If the power source is charged below the first predetermined voltage, a low voltage routine is initiated at step 150. The low voltage routine is exemplarily illustrated and described in more depth in FIG. 10. If the power source is charged above the first predetermined voltage, at step 152, the light sources 96 are activated at the predetermined initial intensity. At step 154, the temperature of the lamp assembly 52 is measured.

At step 156, the lamp assembly 52 determines if the temperature thereof is increasing or decreasing. If the temperature is not increasing, at step 158, the intensity of emitted light 24 is increased. Once the intensity of emitted light 24 is increased at step 158, the method proceeds to step 160, where the state of charge of the power supply is tested and then the method returns to step 148. Returning to step 156, if the temperature is greater than the previously measured temperature, the lamp assembly 52 compares the measured temperature to a MAX temperature at step 162. If the lamp assembly 52 temperature exceeds the MAX temperature, as step 164, the intensity of emitted light 24 emitted from light sources 96 is decreased and/or the light sources 96 are deactivated. Upon decreasing the intensity of light emitted from the light sources 96, the method continues to step 160, where the state of charge of the power supply is measured. Returning to step 162, if the temperature is less than the MAX temperature, the intensity of emitted light 24 may be adjusted based on the net rise in temperature at step 166. For example, if the rise in temperature is within a first range (e.g., zero to two degrees Fahrenheit) that is minimal, the light sources 96 may continue to emit the same intensity of light. If the rise in temperature falls in a second range (e.g., three to four degrees), which is greater than the first range, the intensity of emitted light 24 may decrease by a first percentage (e.g., 1-3%). If the rise in temperature falls in a third range (e.g., greater than four degrees), which is greater than the second range, the intensity of emitted light 24 may decrease by a second percentage (e.g., 10-20%), that is greater than the first percentage. The method surrounded by square 168 may continue until the hatch 46 is placed in a closed position, the switch is actuated to an OFF state, the lights progressively dim until reaching an OFF state, and/or any condition is met to deactivate the light sources 96.

If the voltage of the power source is below the first predetermined voltage, as measured in step 148 of FIG. 9, the lamp assembly 52 may enter the method exemplarily illustrated in FIG. 10. The method begins at step 170, which is entered when the power source is below the first predetermined voltage and the lamp assembly 52 is in an activated state. At step 172, the power source is compared to a second predetermined voltage. If the power source is also below the second predetermined voltage, the lamp assembly 52 may deactivate the light sources 96 at step 174. At step 176, if the voltage of the power source is above the second predetermined voltage, the lamp assembly 52 may run in an efficient mode in which a fourth, low intensity (e.g., 10%) of light is emitted from the light sources 96. At step 178, a predetermined amount of time passes before the voltage of the power source is remeasured at step 180. If the newly measured value is above the first predetermined voltage, the method proceeds to step 154 of FIG. 9. If the newly measured voltage is still below the first predetermined voltage, the method returns to step 170. The method may continue until the hatch 46 is in a closed position, the switch is actuated to an OFF state, the first predetermined voltage is exceeded, and/or any condition is met to deactivate the light sources 96.

A variety of advantages may be derived from the use of the present disclosure. For example, use of the disclosed lamp assembly provides a unique aesthetic appearance to the vehicle. Moreover, the lamp assembly may provide lighting around the vehicle. The lamp assembly may be capable of activating light sources that are oriented to convey light forward, laterally outward, downward, and/or rearward of the panel for selectively illuminating various illumination zones individually and/or simultaneously. The lamp assembly may further include a temperature sensor and the lamp assembly may vary the intensity of light emitted from the light sources based on a detected temperature. Moreover, the lamp assembly may activate the light sources at various intensities based on a charge state of a vehicle power source. The lamp assembly may be manufactured at low costs when compared to standard vehicle lighting assemblies.

According to various examples, a vehicle lamp assembly is provided herein. The lamp assembly includes first and second light sources disposed between a housing and a lens. The first light source is configured to direct emitted light rearwardly of the housing and the second light source is configured to direct emitted light laterally outward from the housing. A temperature sensor is operably coupled with a circuit board. An intensity of the emitted light from the first or second light source is varied based on a detected temperature. Examples of the vehicle lamp assembly can include any one or a combination of the following features:
the housing is disposed within a trim panel of a vehicle;
the housing includes a first portion that extends along a first portion of the trim panel and a second portion that extends along a side portion of the trim panel;
a first reflector operably coupled with the first light source and a second reflector operably coupled with the second light source;
the first light source is configured to direct light towards a cargo compartment on the vehicle and the second light source is configured to direct the emitted light laterally outward of the vehicle;
a third light source configured to emit light towards a ground surface proximate a vehicle, the third light source configured to direct the emitted light a distance further from the vehicle than the first light source;
a switch assembly disposed on the circuit board and configured to selectively activate the first, the second, or the third light sources;
the switch assembly is configured as a proximity switch;
an adhesive layer disposed between the proximity switch and a lens to at least partially remove air gaps between the circuit board and the lens;
the circuit board is operably coupled to a controller and the controller is configured to monitor a percentage at which a power supply is charged;
an intensity of emitted light emanated from the first or second light source is varied based on a percent at which the power supply is charged; and/or
the emitted light from the first or second light source is decreased as the temperature of said lamp assembly increases.

Moreover, a method of operating a vehicle lamp assembly is provided herein. The method includes disposing a circuit board and a first light source between a housing and a lens to direct emitted light rearwardly of a vehicle, and a second light source configured to direct emitted light laterally outward from the housing. Next, a temperature of the circuit board, the first light source, the second light source, the housing or the lens is measured through a temperature sensor. An intensity of emitted light from the first or second light source is adjusted based on a detected temperature.

According to some examples, a vehicle lamp assembly is provided herein. The vehicle lamp assembly includes a housing operably coupled with a lens. A circuit board and a light source are between the housing and the lens. A controller is operably coupled with the circuit board and a power source. The intensity of light emitted from the light source is varied based on a detected charge level of the power source. Examples of the vehicle lamp assembly can include any one or a combination of the following features:
a switch assembly disposed on the circuit board and configured to selectively activate the light source; and/or
the switch assembly is configured as a proximity switch.

According to other examples, a vehicle lamp assembly is disclosed. The lamp assembly includes a circuit board and a light source between a housing and a lens. A controller is operably coupled with the circuit board and a power source. An intensity of emitted light from the light source is varied based on a detected charge level of the power source. A temperature sensor is operably coupled to the circuit board. The intensity of light emitted from the first or second light source is varied based on a detected temperature. Examples of the vehicle lamp assembly can include any one or a combination of the following features:
a switch assembly disposed on the circuit board and configured to selectively activate the light source;
the switch assembly is configured as a proximity switch;
an adhesive layer disposed between the proximity switch and a lens to at least partially remove air gaps between the circuit board and the lens; and/or
the housing is disposed within a trim panel and the light source is configured to direct emitted light at a luminescent structure on a body feature of a vehicle.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle lamp assembly, comprising:
first and second light sources configured to be disposed on a vehicle between a housing and a lens, the first light source configured to direct emitted light rearwardly of the vehicle and the second light source configured to direct emitted light laterally from the vehicle; and
a temperature sensor operably coupled with a circuit board, wherein an intensity of the emitted light from the first or second light source is varied based on a detected temperature.

2. The vehicle lamp assembly of claim 1, wherein the housing is disposed within a trim panel of a vehicle.

3. The vehicle lamp assembly of claim 2, wherein the housing includes a first portion that extends along a first portion of the trim panel and a second portion that extends along a side portion of the trim panel.

4. The vehicle lamp assembly of claim 1, further comprising:
a first reflector operably coupled with the first light source and a second reflector operably coupled with the second light source.

5. The vehicle lamp assembly of claim 1, wherein the first light source is configured to direct light towards a cargo compartment on the vehicle and the second light source is configured to direct the emitted light laterally outward of the vehicle.

6. The vehicle lamp assembly of claim 5, further comprising:
a third light source configured to emit light towards a ground surface proximate the vehicle, the third light source configured to direct the emitted light a distance further from the vehicle than the first light source.

7. The vehicle lamp assembly of claim 6, further comprising:
a switch assembly disposed on the circuit board and configured to selectively activate the first, the second, or the third light sources.

8. The vehicle lamp assembly of claim 7, wherein the switch assembly is configured as a proximity switch.

9. The vehicle lamp assembly of claim 8, further comprising:
an adhesive layer disposed between the proximity switch and a lens to reduce air gaps between the circuit board and the lens.

10. The vehicle lamp assembly of claim 1, wherein the circuit board is operably coupled to a controller and the controller is configured to monitor a percentage at which a power supply is charged.

11. The vehicle lamp assembly of claim 10, wherein an intensity of emitted light emanated from the first or second light source is varied based on a percent at which the power supply is charged.

12. The vehicle lamp assembly of claim 1, wherein the emitted light from the first or second light source is decreased as the temperature of said lamp assembly increases.

13. A vehicle lamp assembly, comprising:
a housing operably coupled with a lens, wherein the housing is disposed in a hatch of a vehicle;
a circuit board and a light source disposed between the housing and the lens, wherein the light source emits light when the hatch is in an open position; and
a controller operably coupled with the circuit board and a power source, wherein the intensity of light emitted from the light source is varied based on a detected charge level of the power source.

14. The vehicle lamp assembly of claim 13, further comprising:
a switch assembly disposed on the circuit board and configured to selectively activate the light source.

15. The vehicle lamp assembly of claim 14, wherein the switch assembly is configured as a proximity switch.

16. A vehicle lamp assembly, comprising:
a circuit board and a light source between a housing and a lens, wherein the housing is disposed in a closure member of a vehicle;
a controller operably coupled with the circuit board and a power source, wherein an intensity of emitted light from the light source is varied based on a detected charge level of the power source; and
a temperature sensor operably coupled with the circuit board, wherein the intensity of light emitted from the light source is varied based on a detected temperature.

17. The vehicle lamp assembly of claim 16, further comprising:
a switch assembly disposed on the circuit board and configured to selectively activate the light source.

18. The vehicle lamp assembly of claim 17, wherein the switch assembly is configured as a proximity switch.

19. The vehicle lamp assembly of claim 18, further comprising:
an adhesive layer disposed between the proximity switch and a lens to reduce air gaps between the circuit board and the lens.

20. The lamp assembly for a vehicle of claim 18, wherein the housing is disposed within a trim panel and the light source is configured to direct emitted light at a luminescent structure on a body feature of the vehicle.
